(19) United States
(12) Patent Application Publication
(10) Pub. No.: US 2026/0023627 A1
(43) Pub. Date: Jan. 22, 2026

(54) METHOD AND SYSTEM FOR MESSAGE AUGMENTATION

(71) Applicant: The Toronto-Dominion Bank, Toronto (CA)

(72) Inventors: Alexander Stuart MORRIS, Toronto (CA); Milos DUNJIC, Oakville (CA)

(73) Assignee: The Toronto-Dominion Bank, Toronto (CA)

(21) Appl. No.: 19/011,796

(22) Filed: Jan. 7, 2025

Related U.S. Application Data
(60) Provisional application No. 63/672,312, filed on Jul. 17, 2024.

(51) Int. Cl. G06F 9/54

(52) U.S. Cl. CPC G06F 9/546

(57) ABSTRACT

A server computer system includes at least one processor; a communications module coupled to the at least one processor; and a memory coupled to the at least one processor, the memory storing instructions that, when executed, configure the at least one processor to receive, via the communications module, a signal that includes messaging data indicating a data transfer; analyze the messaging data to identify a data destination and to extract at least one element; retrieve at least one static element associated with the data destination; augment a response message to include the at least one element and the at least one static element; and send, via the communications module, the augmented response message.

### CROSS-REFERENCE TO RELATED APPLICATIONS

This application claims priority to U.S. Provisional Application No. 63/672,312, filed Jul. 17, 2024, the entire contents of which are incorporated herein by reference.

### TECHNICAL FIELD

The present application relates to methods and systems for message augmentation.

### BACKGROUND

Computer messages are often transmitted in accordance with standardized protocols. These protocols typically define rigidly structured formats to ensure interoperability and automation between systems. However, these standardized formats may present challenges when modifications or extensions are needed. Due to the fixed structure of these standardized formats, incorporating additional information or adjusting the message format to accommodate evolving requirements is cumbersome and error-prone. This rigidity can result in inefficient data handling and computational bottlenecks in downstream systems, which are forced to process these inflexible message formats in ways that are not optimized for their intended purpose, leading to increased processing time and resource consumption.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 shows, in flowchart form, an example method for message augmentation; and

FIG. 6 shows a portion of an example augmented message.

Like reference numerals are used in the drawings to denote like elements and features.

### DETAILED DESCRIPTION OF VARIOUS EMBODIMENTS

Accordingly, in one aspect there is provided a server computer system, comprising at least one processor; a communications module coupled to the at least one processor; and a memory coupled to the at least one processor, the memory storing instructions that, when executed, configure the at least one processor to receive, via the communications module, a signal that includes messaging data indicating a data transfer; analyze the messaging data to identify a data destination and to extract at least one element; retrieve at least one static element associated with the data destination; augment a response message to include the at least one element and the at least one static element; and send, via the communications module, the augmented response message.

In one or more embodiments, the instructions, when executed, further configure the at least one processor to consult a database to retrieve the at least one static element associated with the data destination.

In one or more embodiments, the instructions, when executed, further configure the at least one processor to generate a unique number for the data transfer; and augment the response message to include the unique number for the data transfer.

In one or more embodiments, the at least one static element includes data identifying the data destination.

In one or more embodiments, the augmented response message includes electronic data configured to be processed automatically by at least one third party server computer system.

In one or more embodiments, the augmented response message includes a transmission acknowledgement for the data transfer.

In one or more embodiments, the augmented response message is configured as part of remittance data.

In one or more embodiments, the at least one element extracted from the messaging data includes at least data identifying a data source of the data transfer.

In one or more embodiments, the augmented response message includes a Uniform Resource Locator (URL) within an ISO 20022 response.

In one or more embodiments, the augmented response message includes a payment confirmation message.

According to another aspect there is provided a computer-implemented method comprising receiving, via a communications module, a signal that includes messaging data indicating a data transfer; analyzing the messaging data to identify a data destination and to extract at least one element; retrieving at least one static element associated with the data destination; augmenting a response message to include the at least one element and the at least one static element; and sending, via the communications module, the augmented response message.

In one or more embodiments, the method further comprises consulting a database to retrieve the at least one static element associated with the data destination.

In one or more embodiments, the method further comprises generating a unique number for the data transfer; and augmenting the response message to include the unique number for the data transfer.

In one or more embodiments, the at least one static element includes data identifying the data destination.

In one or more embodiments, the augmented response message includes electronic data configured to be processed automatically by at least one third party server computer system.

In one or more embodiments, the augmented response message includes a transmission acknowledgement for the data transfer.

In one or more embodiments, the augmented response message is configured as part of remittance data.

In one or more embodiments, the at least one element extracted from the messaging data includes at least data identifying a data source of the data transfer.

In one or more embodiments, the augmented response message includes a Uniform Resource Locator (URL) within an ISO 20022 response.

According to another aspect there is provided a non-transitory computer readable storage medium comprising computer-executable instructions which, when executed, configure at least one processor to receive, via a communications module, a signal that includes messaging data indicating a data transfer; analyze the messaging data to identify a data destination and to extract at least one element; retrieve at least one static element associated with the data destination; augment a response message to include the at least one element and the at least one static element; and send, via the communications module, the augmented response message.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

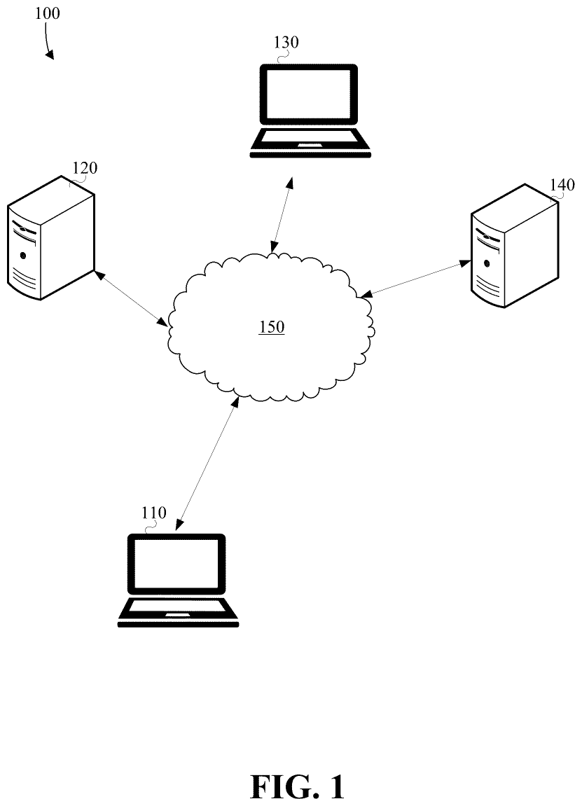

FIG. 1 is a block diagram illustrating an operating environment of an example embodiment. Various components cooperate to provide a system 100. As shown, the system 100 includes a first client device 110, a first server computer system 120, a second client device 130, and a second server computer system 140 coupled to one another through a network 150.

The first client device 110 and the second client device 130 are configured to communicate with the first server computer system 120 and the second server computer system 140 via the network 150 and vice-versa. The first client device 110 and the second client device 130 may be remote from the first server computer system 120 and the second server computer system 140.

The first server computer system 120 is configured to communicate with the second server computer system 140 via the network 150 and vice-versa. The first server computer system 120 may be remote from the second server computer system 140.

The first client device 110 may be associated with a transferor. The first client device 110 may be a laptop computer as shown in FIG. 1. However, the first client device 110 may be a computing device of another type such as for example a mobile device, a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The second client device 130 may be associated with a transferee. The second client device 130 may be a laptop computer as shown in FIG. 1. However, the second client device 130 may be a computing device of another type such as for example a mobile device, a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The first server computer system 120 may be referred to as a transfer server and may be configured to complete transfers according to transfer requests initiated by the transferor. In at least some embodiments, the first server computer system 120 may be a financial institution server. In these embodiments, the first server computer system 120 may maintain a database that includes various data records. A data record may, for example, reflect an amount of value stored in a particular account. The transfers may be completed by transferring value from a particular account maintained by the first server computer system 120.

The second server computer system 140 may be referred to as a transferee server. In at least some embodiments, the second server computer system 140 may be a financial institution server. In these embodiments, the second server computer system 140 may maintain a database that includes various data records. A data record may, for example, reflect an amount of value stored in a particular account. The transfers may be completed by transferring value from a particular account maintained by the second server computer system 140.

The network 150 is a computer network. The network 150 may include a public network such as the Internet and/or a private network. In some embodiments, the network 150 may be an internetwork such as may be formed of one or more interconnected computer networks. For example, the network 150 may be or may include an Ethernet network, a wireless network, a telecommunications network, or the like.

The first server computer system 120 may be configured to send transfers in response to a transfer request received from the first client device 110. As will be described in more detail below, the second server computer system 140 may be configured to receive transfers from the first server computer system 120 and may perform operations for message augmentation.

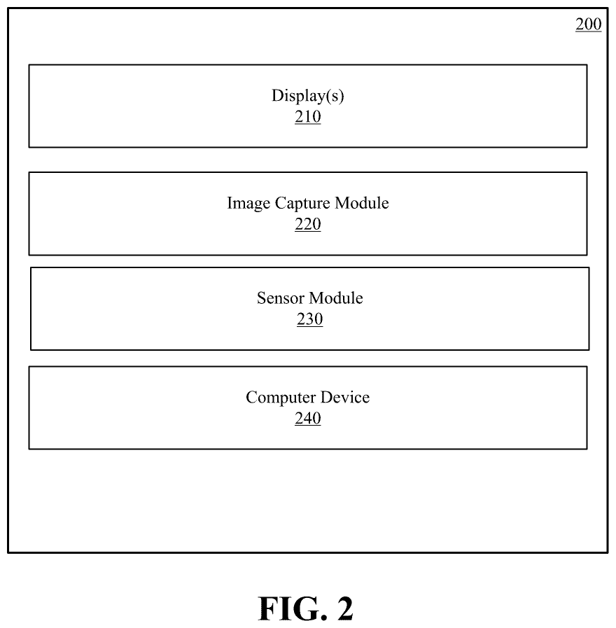

FIG. 2 is a simplified schematic diagram showing components of an exemplary computing device 200. The first client device 110 and the second client device 130 may be of the same type as computing device 200. The computing device 200 may include modules including, as illustrated, for example, one or more displays 210, an image capture module 220, a sensor module 230, and a computer device 240.

The one or more displays 210 are a display module. The one or more displays 210 are used to display screens of a graphical user interface that may be used, for example, to communicate with the first server computer system 120 (FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates location data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 240 is in communication with the one or more displays 210, the image capture module 220, and the sensor module 230. The computer device 240 may be or may include a processor which is coupled to the one or more displays 210, the image capture module 220, and/or the sensor module 230.

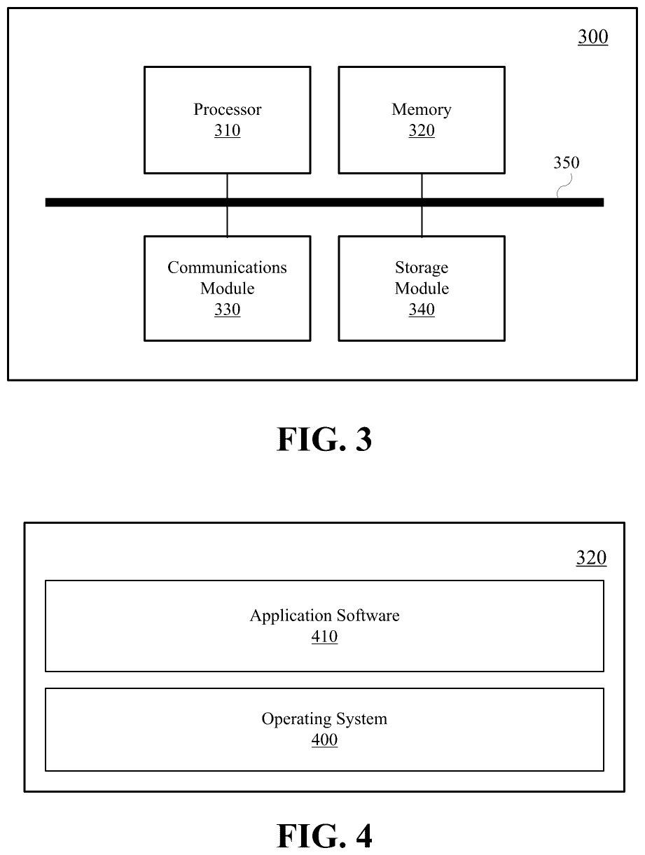

Referring now to FIG. 3, a high-level operation diagram of an example computer device 300 is shown. In some embodiments, the computer device 300 may be exemplary of the computer device 240 (FIG. 2), the first server computer system 120 and/or the second server computer system 140.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2), the first server computer system 120 and/or the second server computer system 140.

While a single application 410 is illustrated in FIG. 4, in operation the memory 320 may include more than one application 410 and different applications 410 may perform different operations. For example, in at least some embodiments in which the computer device 300 functions as the first client device 110, the applications 410 may include a banking application. The banking application may be configured for secure communications with the first server computer system 120 and may provide various banking functions such as, for example, initiating a transfer.

By way of further example, in at least some embodiments in which the computer device 300 functions as the first client device 110, the applications 410 may include a web browser, which may also be referred to as an Internet browser. In at least some such embodiments, the first server computer system 120 may be a web server. The web server may cooperate with the web browser and may serve as an interface when the interface is requested through the web browser. For example, the web browser may serve as a mobile banking interface. The mobile banking interface may provide various banking functions such as, for example, initiating a transfer.

As mentioned, the first server computer system 120 may be configured to send transfers in response to a transfer request received from the first client device 110. The second server computer system 140 may be configured to receive transfers from the first server computer system 120 and may perform operations for message augmentation.

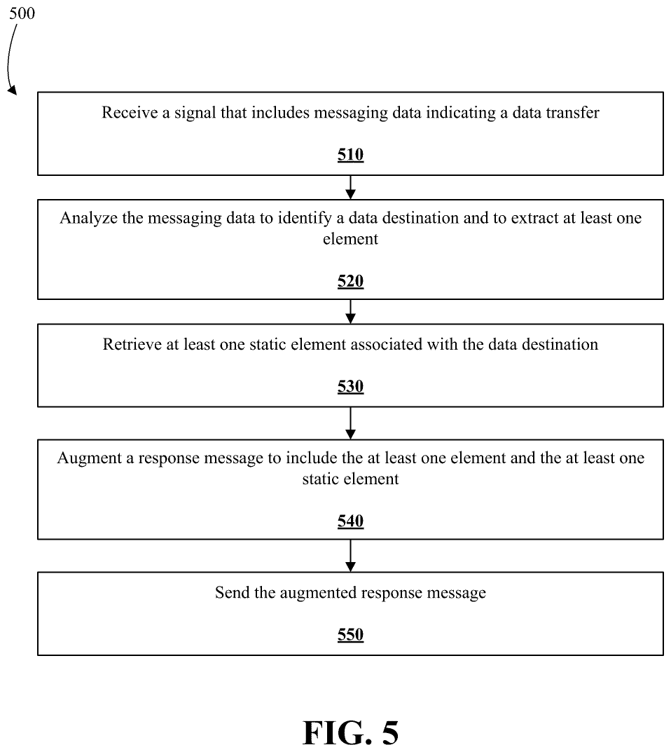

Reference is made to FIG. 5, which illustrates, in flowchart form, a method 500 for message augmentation. The method 500 may be implemented by a computing device having suitable processor-executable instructions for causing the computing device to carry out the described operations. The method 500 may be implemented, in whole or in part, by the second server computer system 140. At least some of the operations may be performed or otherwise offloaded to one or more of the external data sources, as will be described.

The method 500 includes receiving a signal that includes messaging data indicating a data transfer (step 510).

In one or more embodiments, the messaging data is received from the first server computer system 120. For example, a data source such as for example a transferor may operate the first client device 110 to initiate the data transfer and in response the first client device 110 may generate a data transfer request to the first server computer system 120. The first server computer system 120 may analyze the data transfer request to identify the data destination such as for example the transferee. Further, the first server computer system 120 may analyze the data transfer request to identify a financial institution associated with the data destination and this may be, for example, the second server computer system 140.

The first server computer system 120 may send the messaging data indicating the data transfer in a particular format that includes at least one element. The at least one element may include, for example, a message header, payment information, data identifying a data source of the data transfer such as for example an identity of the transferor, an account of the transferor, the financial institution of the transferor. The at least one element may also include data destination information such as for example an identity of the transferee, a financial institution of the transferee, an account of the transferee. The at least one element may include a data transfer amount. The at least one element may include additional types of data such as for example a date of the data transfer.

In one or more embodiments, the messaging data indicating the data transfer may be in an ISO 20022 format and may include, for example, an inbound payment message. For example, the inbound payment message may include a Customer Credit Transfer (pacs.008) or Payment Status Report (pacs.002) message type. The Customer Credit Transfer (pacs.008) message may include a group header that includes message identifiers, creation time, and initiating party details. The initiating party in this example includes the transferor. The Customer Credit Transfer (pacs.008) message may include payment information that specifies the payment method, execution date, and includes the debtor/creditor details. The Customer Credit Transfer (pacs.008) message may include remittance information that may include structured or unstructured information about the transfer.

The messaging data indicating the data transfer may be received via a network such as for example a payment network or payment rail.

The method 500 includes analyzing the messaging data to identify a data destination and to extract at least one element (step 520).

Once the messaging data is received, the messaging data is analyzed to identify the data destination and to extract the at least one element. The data destination may identify, for example, a transferee.

In one or more embodiments, the at least one element extracted from the messaging data may include at least data identifying a data source of the data transfer. The data source may include, for example, an identity of the transferor.

In one or more embodiments, the messaging data indicating the data transfer may be in a particular format that includes the at least one element. As mentioned, the at least one element may include, for example, a message header, payment information, data identifying a data source of the data transfer such as for example an identity of the transferor, an account of the transferor, the financial institution of the transferor. The at least one element may also include data destination information such as for example an identity of the transferee, a financial institution of the transferee, an account of the transferee. The at least one element may include a data transfer amount. The at least one element may include additional types of data such as for example a date of the data transfer. As such, the data may be analyzed to identify the data destination and to extract the at least one element.

As mentioned, in one or more embodiments, the messaging data indicating the data transfer may be in an ISO 20022 format and may include, for example, an inbound payment message. In these embodiments, the second server computer system 140 may analyze the message data to identify the data destination and to extract the at least one element in the following manner. The second server computer system 140 may parse the inbound payment message. For example, the second server computer system 140 may utilize an Extensible Markup Language (XML) parser to load and parse the inbound payment message. Using the XML parser, the second server computer system 140 may identify specific XML namespaces and may locate one or more fields to identify the data destination and the at least one element. For example, data destination fields may be located that include the data destination such as for example an identity or name of the transferee and/or an account of the transferee. As another example, data destination fields may be located that include the at least one element such as for example data identifying a data source of the data transfer, where the data source may include, for example, an identity of the transferor.

In one or more embodiments, the second server computer system 140 may engage an artificial intelligence (AI) engine that may be trained to analyze inbound messaging data and this may be done to handle complex or variable structures, detect anomalies, and to automate processes. The AI engine may include one or more natural language processing (NLP) models to parse unstructured fields to identify useful details such as for example the data destination. The one or more NLP models may be trained to adapt to variations in formatting and proprietary extensions by learning patterns across message samples.

In one or more embodiments, the AI engine may be trained using labeled datasets of messaging data such as for example inbound payment messages in XML and other structure formats, including ISO 20022. The training data may include historical inbound payment messages with known outcomes such as transferee names, account numbers, and associated metadata. Supervised learning techniques may be utilized where the AI engine may learn to map inbound payment message data, including structured fields such as for example <Cdtr> and <CdtrAcct> and unstructured fields such as for example <Ustrd> to labeled output (e.g., correct identification of transferee name and account). A combination of feature extraction methods and deep learning models may be used to capture both syntactic and semantic relationships within the data.

Once trained, the AI engine may be utilized. For example, upon receiving a new inbound payment message, the second server computer system 140 may parse the XML structure, passing both structured and unstructured data to the AI engine. The AI engine may predict the data destination and the at least one element, and may also detect potential errors and inconsistencies, like mismatched names and account details, using anomaly detection. In this manner, the second server computer system 140 may utilize the AI engine to identify the data destination and to extract the at least one element.

The method 500 includes retrieving at least one static element associated with the data destination (step 530).

In one or more embodiments, the at least one static element associated with the data destination may be retrieved from a database. For example, the second server computer system 140 may identify the data destination and may perform a lookup in the database using the identity of the data destination to retrieve the at least one static element.

The at least one static element may include, for example, at least one of a name of the data destination, an address of the data destination, or a registration number of the data destination. Of course, in embodiments where the data destination includes a transferee, the at least one static element may include, for example, at least one of a name of the transferee, an address of the transferee, or a registration number of the transferee.

The at least one static element may include a unique credential and/or alias for the data destination. For example, the second server computer system 140 may have created the unique credential or alias for the data destination that may be used to receive data transfers and to issue receipts against.

The method 500 includes augmenting a response message to include the at least one element and the at least one static element (step 540).

In one or more embodiments, augmenting the response message may include merging or otherwise combining the at least one element and the at least one static element. For example, in embodiments where the data source includes a transferor and the data destination included a transferee, augmenting the response message may include merging or otherwise combining the transferor's name, the transfer amount, and the date with the identity of the transferee, the address of the transferee, and the registration number of the transferee.

It will be appreciated that one or more other elements may be included. For example, a unique number may be generated for the data transfer and the unique number may be included in the augmented response message. Other elements may include, for example, a time and date of the data transfer.

In one or more embodiments, the augmented response message may include a payment confirmation response message which may be in an ISO 20022 format. The augmented response message may include, for example, a message identification number, original transfer information, data transfer status, settlement information, party information (transferor, transferee), an amount of the data transfer, etc.

In one or more embodiments, the augmented response message may contain the at least one element and the at least one static element contained in a Uniform Resource Locator (URL) response within an ISO 20022 response. For example, a custom XML extension may be defined in the ISO 20022 message that includes the URL.

In one or more embodiments, the augmented response message may be configured as part of remittance data. For example, the augmented response message may be embedded in remittance data. Specifically, the remittance information element of an ISO 20022 message may be utilized to include the at least one element and the at least one static element. In one or more embodiments, structured remittance data may be used to provide the at least one element and the at least one static element. Further, an additional remittance line may be utilized to provide a secure URL for accessing the at least one element and the at least one static element.

In one or more embodiments, the at least one element and the at least one static element may be combined to generate a donation receipt for the data transfer and the augmented response message may include the donation receipt. In one or more embodiments, the augmented response message may contain the donation receipt in the URL response within the ISO 20022 response. In one or more embodiments, the augmented response message may be configured as part of remittance data and may include the receipt for the data transfer. For example, the donation receipt may be embedded in remittance data. Specifically, the remittance information element of an ISO 20022 message may be utilized to include the donation receipt. In one or more embodiments, structured remittance data may be used to provide the donation receipt. Further, an additional remittance line may be utilized to provide a secure URL for accessing the donation receipt.

In one or more embodiments, the augmented response message includes electronic data configured to be processed automatically by one or more computer server systems.

In one or more embodiments, the augmented response message may include an ISO 20022 payment confirmation message augmented with a donation receipt. The donation receipt may include all information required for acknowledgement that a donation was made by a transferor (donor) to a transferee (a charity).

The response message may be augmented in real-time to include the at least one element and the at least one static element and as such latency and computational overhead is reduced. Further, embedding concise data such as the at least one element and the at least one static element in structured remittance data reduces data duplication and optimizes network usage, which improves system performance.

The method 500 includes sending the augmented response message (step 550).

In one or more embodiments, the augmented response message may be sent to an electronic address of a data source which may include a transferor.

In one or more embodiments, such as for example when the data indicating the transfer is received via a payment network, the augmented response message may be sent via the payment network.

The augmented response message may be stored in memory by the second server computer system 140 and/or the first server computer system 120 such that data included with the augmented response message may be retrieved by the data source or the data destination.

In one or more embodiments, the augmenting of the response message may be selective based on the data transfer amount. For example, the response message may only be augmented in the event that the data transfer amount exceeds a threshold.

In accordance with one or more embodiments described herein, by embedding donation receipt information in the remittance data or URL, the systems and methods described herein avoid the need for separate donation receipt generation systems.

In accordance with one or more embodiments described herein, by integrating URL responses with the ISO 20022 message, the systems and methods described herein minimize data transfer and processing time.

In accordance with one or more embodiments described herein, the systems and methods described herein augment a payment confirmation response message to automatically include donation receipt data and this eliminates manual intervention, improves system responsiveness and reduces server load.

In manners described herein, a payment confirmation response message may be modified to include a receipt such as for example a donation receipt. The data used to generate the donation receipt may be generated through a combination of data obtained from the payment message itself and preconfigured information associated with the transferee or beneficiary of the transfer and unique data such as for example a unique serial number of the receipt. It will be appreciated that other types of receipts may be included.

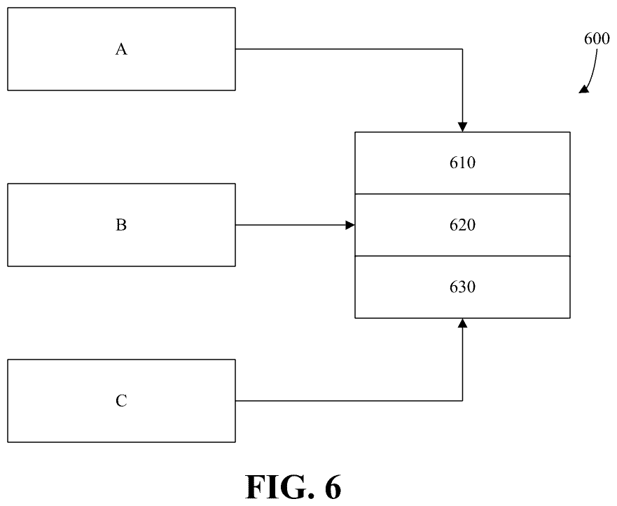

In one or more embodiments described herein, the second server computer system 140 may process an inbound message and may respond with an augmented response message. The augmented response message may include data obtained from a number of data sources. A portion of an example augmented response message 600 is shown in FIG. 6. In this example, data from a data source A, data from a data source B, and data from a data source C is obtained and combined to generate the portion of the example augmented response message 600. The data source A may include the inbound message and data elements 610 may be extracted from inbound message. The data source B may include a database and static data elements 620 associated with the data element 610 may be extracted from the database. The data source C may include a software module such as for example a random number generator that may be used to generate a unique number for the data transfer and this may be included as additional data element 630. By extracting or obtaining data from a number of data sources, the second server computer system 140 may generate the augmented response message to include the extracted or obtained data and this may eliminate downstream requirements to perform additional operations to extract or obtain this data.

An example of the method 500 will now be provided. In this example, a data source that includes a transferor (donor) may send a data transfer via the first server computer system 120 to a data destination that includes a transferee (charity) that has an account maintained by the second server computer system 140.

The second server computer system 140 may create and store a unique credential or alias for the transferee that may be used to receive donations and to issue receipts.

Upon receipt of an inbound payment to the unique credential or alias, the second server computer system 140 may process the payment confirmation message uniquely to respond with a donation receipt. Specifically, the second server computer system 140 may extract data elements from the inbound payment message such as the transferor's name, amount and date. These elements may be merged with static elements unique to the transferee that is already stored in a database associated with the second server computer system 140. The static elements may include the transferee's name, address, and charitable registration number. Additional data may be merged such as for example the time and date of receipt issuance and a unique serial number as required when issuing donation receipts. All of the data elements may be provided in a response back to the network or directly to the transferor and/or transferee depending on which payment rail the original payment was sent with. The response may be configured as part of the remittance data, be contained in a URL response within the ISO20022 response or be configured as a direct email back to the transferor. In parallel, the second server computer system 140 may provide a copy of the donation receipt that was generated directly to the transferee to store for their records. The transferor thereby receives confirmation that the payment was successfully received by the transferee and also receives a donation receipt that is in compliance with requirements for the issuance of charitable donation receipts.

Existing systems for processing financial transactions rely on standardized message formats, such as the ISO 20022 protocol, for communication between systems. These protocols define rigidly structured message formats to ensure interoperability across platforms. However, these rigid structures may limit the ability to incorporate additional or dynamically generated data, such as updated payment context or compliance information, into response messages.

In typical implementations, when a payment message is received, a confirmation response must be generated and sent back in the same rigid format. The inherent limitation of these message structures prevents the efficient addition of new data without disrupting the established standard, leading to computational inefficiencies in downstream systems. These inefficiencies may include the need for additional processing time, increased system complexity, and the potential for errors due to the lack of flexibility in the message format.

In accordance with one or more embodiments described herein, the technical challenges relating to ISO 20022 protocol are addressed at least by modifying or extending the message structure to incorporate dynamic data elements without violating the underlying standards. By enabling more efficient integration of additional information, one or more of the embodiments described herein reduces the computational overhead and improves the overall processing efficiency of downstream systems. The methods and systems described herein provide a technological improvement in the handling of structured communication messages, ensuring that data can be effectively modified or extended while maintaining compatibility with existing communication protocols.

In accordance with one or more embodiments described herein, when donation receipt data is included or embedded in the payment confirmation message (e.g., ISO 20022 response), downstream systems are able to directly ingest and process the donation receipt data. As such, these downstream systems may automatically extract both payment and donation receipt data, eliminating manual input, reducing errors, and speeding up the reconciliation process. Further, by embedding the donation receipt data in the payment confirmation message, transfer amounts, transferor identities, and transfer dates are consistently recorded ensuring accurate record management.

In accordance with one or more embodiments described herein, by embedding donation receipt data in the payment confirmation message, interoperability between different systems is improved. For example, since the donation receipt data is embedded in a standardized payment confirmation message, the augmented response message may be easily integrated with various systems. Further, since the donation receipt data is included in the payment confirmation message, there is less need for duplicating data in multiple systems and this reduces data silos.

The methods described above may be modified and/or operations of such methods combined to provide other methods.

Furthermore, the description above generally describes operations that may be performed by a server and a client device in cooperation with one another. Operations that are described as being performed by the server may, instead, be performed by the client device.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A server computer system, comprising:
at least one processor;
a communications module coupled to the at least one processor; and
a memory coupled to the at least one processor, the memory storing instructions that, when executed, configure the at least one processor to:
receive, via the communications module, a signal that includes messaging data indicating a data transfer;
analyze the messaging data to identify a data destination and to extract at least one element;
retrieve at least one static element associated with the data destination;
augment a response message to include the at least one element and the at least one static element; and
send, via the communications module, the augmented response message.

2. The server computer system of claim 1, wherein the instructions, when executed, further configure the at least one processor to:
consult a database to retrieve the at least one static element associated with the data destination.

3. The server computer system of claim 1, wherein the instructions, when executed, further configure the at least one processor to:
generate a unique number for the data transfer; and
augment the response message to include the unique number for the data transfer.

4. The server computer system of claim 1, wherein the at least one static element includes data identifying the data destination.

5. The server computer system of claim 1, wherein the augmented response message includes electronic data configured to be processed automatically by at least one third party server computer system.

6. The server computer system of claim 1, wherein the augmented response message includes a transmission acknowledgement for the data transfer.

7. The server computer system of claim 1, wherein the augmented response message is configured as part of remittance data.

8. The server computer system of claim 1, wherein the at least one element extracted from the messaging data includes at least data identifying a data source of the data transfer.

9. The server computer system of claim 1, wherein the augmented response message includes a Uniform Resource Locator (URL) within an ISO 20022 response.

10. The server computer system of claim 1, wherein the augmented response message includes a payment confirmation message.

11. A computer-implemented method comprising:
receiving, via a communications module, a signal that includes messaging data indicating a data transfer;
analyzing the messaging data to identify a data destination and to extract at least one element;
retrieving at least one static element associated with the data destination;
augmenting a response message to include the at least one element and the at least one static element; and
sending, via the communications module, the augmented response message.

12. The computer-implemented method of claim 11, further comprising:
consulting a database to retrieve the at least one static element associated with the data destination.

13. The computer-implemented method of claim 11, further comprising:
generating a unique number for the data transfer; and
augmenting the response message to include the unique number for the data transfer.

14. The computer-implemented method of claim 11, wherein the at least one static element includes data identifying the data destination.

15. The computer-implemented method of claim 11, wherein the augmented response message includes electronic data configured to be processed automatically by at least one third party server computer system.

16. The computer-implemented method of claim 11, wherein the augmented response message includes a transmission acknowledgement for the data transfer.

17. The computer-implemented method of claim 11, wherein the augmented response message is configured as part of remittance data.

18. The computer-implemented method of claim 11, wherein the at least one element extracted from the messaging data includes at least data identifying a data source of the data transfer.

19. (canceled)

20. A non-transitory computer readable storage medium comprising computer-executable instructions which, when executed, configure at least one processor to:
receive, via a communications module, a signal that includes messaging data indicating a data transfer;
analyze the messaging data to identify a data destination and to extract at least one element;
retrieve at least one static element associated with the data destination;
augment a response message to include the at least one element and the at least one static element; and
send, via the communications module, the augmented response message.

21. The server computer system of claim 1, wherein when analyzing the messaging data to identify the data destination and to extract the at least one element, the instructions, when executed, further configure the at least one processor to:
engage an artificial intelligence engine to identify the data destination and to extract the at least one element.
